(19) United States
(12) Patent Application Publication
(10) Pub. No.: US 2012/0294638 A1
(43) Pub. Date: Nov. 22, 2012

(54) IMAGE FORMING DEVICE AND CONTROL METHOD THEREOF

(75) Inventor: Hiroshi MATSUMOTO, Tokyo (JP)

(73) Assignee: KONICA MINOLTA BUSINESS TECHNOLOGIES, INC., Tokyo (JP)

(21) Appl. No.: 13/459,543

(22) Filed: Apr. 30, 2012

(30) Foreign Application Priority Data
May 17, 2011 (JP) 2011-110257

(51) Int. Cl. G03G 13/20; G03G 15/20

(52) U.S. Cl. 399/67

(57) ABSTRACT

An image forming device includes an image forming section, a fixing unit, an oscillation mechanism and a controller. The image forming section forms an image on a sheet. The fixing unit thermally fix the image on the sheet by using a fixing rotating member to pinch and convey the sheet on which the image has been formed by the image forming section. The oscillation mechanism oscillates at least the fixing rotating members of the fixing unit in an axial direction thereof. The controller controls the oscillation mechanism to cause the fixing rotating members not to oscillate while the sheet is being pinched and conveyed simultaneously by the fixing rotating members and other rotating members.

### BACKGROUND OF THE INVENTION

1. Field of the Invention

The present invention relates to an image forming device and a control method thereof.

2. Description of Related Art

Conventionally, in an image forming device, a fixing unit is used for fixing an image formed on paper. A fixing unit thermally fixes an image on paper by pinching and conveying the paper on which the image is already formed, by using a fixing rotating member provided with heating unit such as a halogen lamp heater inside thereof. As such a fixing rotating member, a pair of rollers including a heating roller having heating unit and a pressure roller, a fixing belt extended between a pair of rollers, or the like is used.

In the conventional fixing unit, paper passes through a same area of the fixing rotating member, which causes a scar in an area of the fixing rotating member which comes in contact with a side end section of paper (hereinafter referred to as a paper end), and the scar deteriorates quality of images. To solve this problem, a technique has been proposed for preventing paper from passing through a same area of a fixing rotating member by oscillating the fixing rotating member in the axis direction thereof, in other words, in the direction orthogonal to a paper conveying direction (see Japanese Unexamined Patent Application Laid-open Publication No. 2006-91224, for example). An image forming device which includes a swinging mechanism configured to swing the whole fixing unit as the means of swinging the fixing rotating members is also proposed.

By the way, there has been a problem that, when the fixing rotating member oscillates while paper is pinched and conveyed by a pair of rollers of a fixing unit and another pair of rollers at the same time, a defect such as misalignment of an image, a wrinkle of paper or the like happens. Especially when the paper is conveyed by a transfer roller configured to transfer a toner image to the paper and the roller pair of the fixing unit at the same time, image misalignment will occur, thus causing degradation in image quality.

### SUMMARY OF THE INVENTION

It is, therefore, an object of the present invention to prevent defects including image misalignment or paper wrinkles caused by the swinging fixing rotating members in the image forming device. To achieve at least one of the above-mentioned objects, an image forming device reflecting one aspect of the present invention, includes an image forming section to form an image on a sheet; a fixing unit to thermally fix the image on the sheet by using a fixing rotating member to pinch and convey the sheet on which the image has been formed by the image forming section; an oscillation mechanism to oscillate at least the fixing rotating members of the fixing unit in an axial direction thereof; and a controller to control the oscillation mechanism to cause the fixing rotating members not to oscillate while the sheet is being pinched and conveyed simultaneously by the fixing rotating members and other rotating members.

Preferably, the other rotating members include transfer rollers for transferring the image onto the sheet.

Preferably, the controller controls the oscillation mechanism to cause the fixing rotating members to swing only when the sheet is not being pinched and conveyed by the fixing rotating members.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a block diagram showing a functional structure of an image forming device according to an embodiment of the present invention;

FIG. 2 is a view showing an example of a rough structure of the image forming device;

FIG. 3 is a view showing an example of a rough structure of an oscillation mechanism of a fixing unit;

FIG. 4 is a timing chart concerning control of oscillation for the fixing unit carried out by a controller shown in FIG. 1 in the first embodiment;

FIG. 5 is a view showing the state of paper when the fixing unit is being oscillated in the case where the control of oscillation is performed for the fixing unit based on the timing chart shown in FIG. 4; and

FIG. 6 is a view showing positional relations of paper, a roller pair of the fixing unit, secondary-transfer rollers, and delivery rollers in the image forming device of the second embodiment.

### DESCRIPTION OF THE PREFERRED EMBODIMENTS

A structure and operation of an image forming device according to an embodiment of the present invention will be explained in detail using the drawings. Although the embodiment of the present invention will be explained taking a color image forming device 1 as an example, the present invention is not limited thereto, and a black-and-white image forming device, for instance, is also be able to achieve the present invention.

### First Embodiment

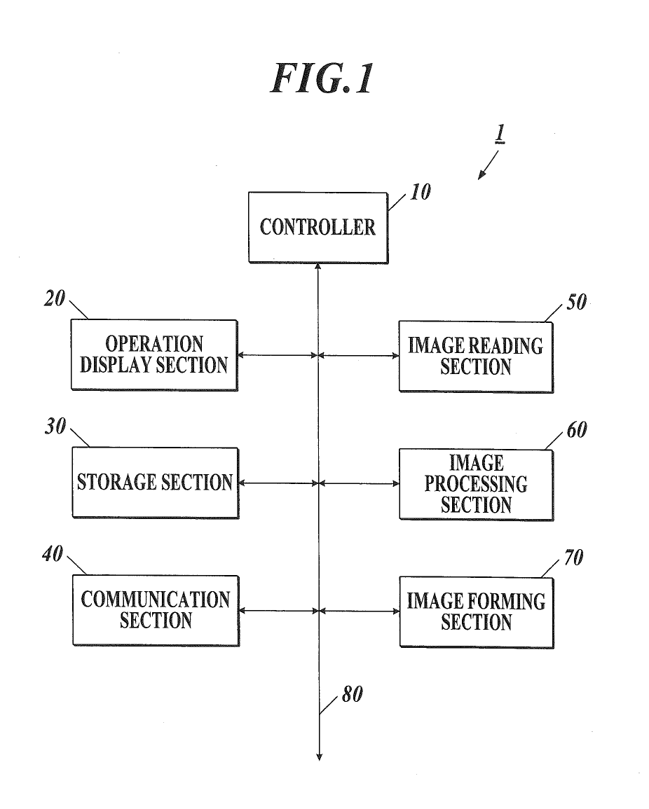

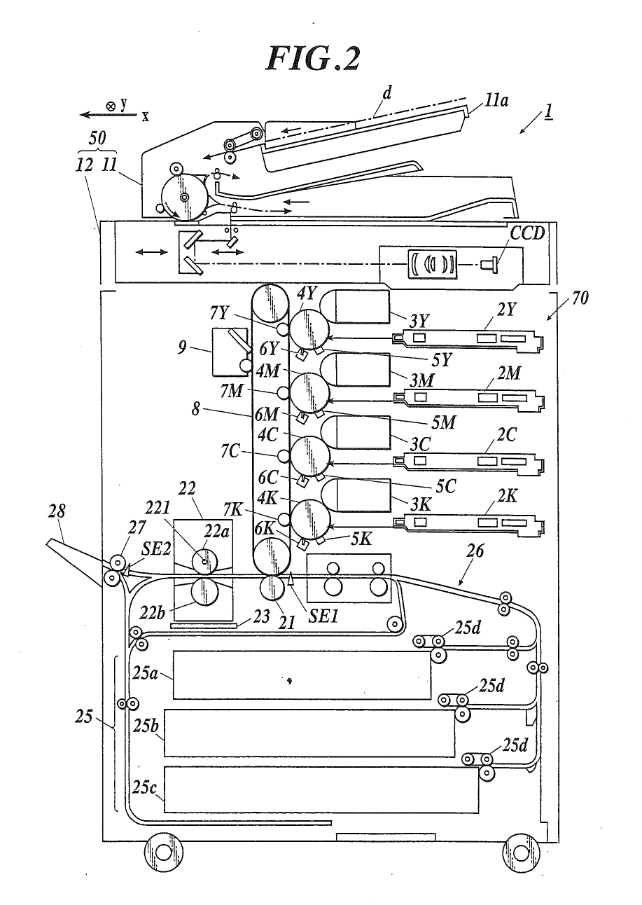

FIG. 1 illustrates an example of a functional block diagram of an image forming device 1. FIG. 2 illustrates an example of a rough structure of the inside of the image forming device 1.

As depicted in FIG. 1, the image forming device 1 is constructed of elements including a controller 10, an operation display section 20, a storage section 30, a communication section 40, an image reading section 50, an image processing section 60, and an image forming section 70, and each of these sections is connected to each other through a bus 80.

The controller 10 is constructed of a CPU (central processing unit), a RAM (random access memory), and the like. The CPU of the controller 10 reads out a system program and various processing programs stored in the storage section 30, expands the programs in the RAM, and performs centralized control of the operation of each of the sections of the image forming device 1 in accordance with expanded programs.

For example, by collaborating with a program stored in the storage section 30, the controller 10 makes the image reading section 50 read an image from a document placed on a document tray 11a, carries out a job based on job information such as the image read from the document and image forming conditions inputted from the operation display section 20, forms the image on paper P (or sheet P), and outputs the same. Also, by collaborating with a program stored in the storage section 30, the controller 10 receives, from the communication section 40, job information including the image data sent from an external device or the like and image forming conditions for each of the image data, carries out a job based on the job information received, forms an image on paper P, and outputs the same.

Further, the controller 10 performs oscillation control for an oscillation mechanism 23 by collaborating with a program stored in the storage section 30.

The operation display section 20 is constructed of a LCD (liquid crystal display) or the like, and displays various operation buttons, a state of the device, a run state of each function, or other information on a display screen thereof in accordance with an instruction of a display signal inputted from the controller 10. The display screen of the LCD is covered by a pressure sensitive (resistive) touch panel constructed by transparent electrodes arranged in a grid-like form, detects a X-Y coordinate of a point of load pressed by a finger or a touch pen as a voltage value, and outputs a detected location signal to the controller 10 as an operation signal. The operation display section 20 further includes various operation buttons such as number buttons and a start button, and outputs an operation signal to the controller 10 by operating a button.

The storage section 30 is structured of a nonvolatile memory or the like, and stores a system program executable in the image forming device 1, various processing programs executable in the system program, data used when executing the various processing programs, data of processing result which has been arithmetically processed by the controller 10, and the like.

The communication section 40 is structured of a modem, a LAM adaptor, a router and the like, carries out communication control with an external device such as a PC (personal computer) connected to a communication network including LAN (local area network), WAN (wide area network) and the like, and receives job information and the like.

As illustrated in FIG. 2, the image reading section 50 is provided with an automatic document feeding section 11 which is known as an ADF (auto document feeder), and a reading section 12. The automatic document feeding section 11 conveys a document d placed on the document tray 11a to a contact glass where the document d is read. The reading section 12 projects light to the document d that has been placed on the contact glass, acquires an image signal of the document d by reading reflected light using a CCD (charge coupled device) and performing photoelectric conversion, and outputs the image signal to the image processing section 60.

The image processing section 60 carries out various image processing such as A/D conversion, shading correction, image compression, on the image (an analog image signal) outputted by the image reading section 50, and thereafter, separates colors into Y (yellow), M (magenta), C (cyan), and K (black), before outputting the image as digital image data to the image forming section 70.

The image forming section 70 forms an image on paper P using an electro photographic method based on the inputted image data. As illustrated in FIG. 2, the image forming section 70 is constructed of exposure units 2Y, 2M, 2C, and 2K, development units 3Y, 3M, 3C, and 3K, photosensitive drums 4Y, 4M, 4C, and 4K, charging sections 5Y, 5M, 5C, and 5K, cleaning sections 6Y, 6M, 6C, and 6K, primary-transfer rollers 7Y, 7M, 7C, and 7K, an intermediate transfer belt 8, a belt cleaning section 9, secondary-transfer rollers 21, the fixing unit 22, the oscillation mechanism 23, the paper feeding section 25, and a conveying section 26 including the delivery rollers 27.

Each of the exposure units 2Y, 2M, 2C, and 2K is structured of elements including a laser light source such as a LD, a polygon mirror, and a plurality of lenses. The exposure units 2Y, 2M, 2C, and 2K perform scanning exposure on the surfaces of the photosensitive drums 4Y, 4M, 4C, and 4K using a laser beam based on image data sent from the image processing unit 60. Due to this scanning exposure with the laser beam, latent images are formed, in other words, the images are written, to the image forming positions of the photosensitive drums 4Y, 4M, 4C and 4K which are charged by the charging sections 5Y, 5M, 5C, and 5C. The image forming positions of the photosensitive drums 4Y, 4M, 4C and 4K are positions on the photosensitive drums where latent images are formed.

The latent images formed on the photosensitive drums 4Y, 4M, 4C, and 4K are then formed into visible images by development carried out by the corresponding development units 3Y, 3M, 3C, and 3K, and the toner image is formed on each of the photosensitive drums 4Y, 4M, 4C, and 4K.

Primary transfer of the toner images formed on and supported by the photosensitive drums 4Y, 4M, 4C, and 4K are carried out by being transferred sequentially to predetermined positions on the intermediate transfer belt 8 by the primary-transfer rollers 7Y, 7M, 7C and 7K.

The cleaning sections 6Y, 6M, 6C, and 6K remove residual toner from the surfaces of the photosensitive drums 4Y, 4M, 4C and 4K, respectively, which have finished transferring the toner images.

The intermediate transfer belt 8 is a semi conductive endless belt which is suspended on and rotatably supported by a plurality of rollers, and is driven to rotate along rotation of the rollers.

This intermediate transfer belt 8 is compressed onto the photosensitive drums 4Y, 4M, 4C, and 4K by the primary-transfer rollers 7Y, 7M, 7C and 7K, respectively. Thus, the toner images respectively developed on the surfaces of the photosensitive drums 4Y, 4M, 4C, and 4K are sequentially transferred onto the intermediate transfer belt 8 by the primary-transfer rollers 7Y, 7M, 7C and 7K, respectively (primary transfer). Meanwhile, paper P of a type instructed by the controller 10 is fed in the paper feeding section 25, and conveyed by the conveying section 26 to a position where the images are transferred by the secondary-transfer rollers 21. Then, the toner images of the color image are transferred to the paper P at the position where the images are to be transferred by the secondary-transfer rollers 21, as the pair transfer rollers 21 pinches and conveys the paper P (secondary transfer). After the transfer, the paper P is conveyed by the fixing unit 22, the toner images transferred to the paper P are thermally fixed, and delivered on the delivery tray 28 by the delivery rollers 27. The delivery rollers 27 are conveying rollers located on the downstream side of the fixing unit 22 in the paper conveying route. Residual toner on the intermediate transfer belt 8 is removed by the belt cleaning section 9.

On the paper transport path of the conveying section 26, there is provided a plurality of photosensors including, for example, the secondary transfer paper detection sensor SE1 and a delivery roller paper sensor SE2. The controller 10 controls motion of each sections of the image forming section 70 based on the outputs from these sensors.

On the conveying route of the conveying section 26, a plurality of photo sensors are provided as detecting unit for detecting a position of paper P. The detecting unit includes a secondary transfer paper detection sensor SE1 for detecting whether paper P is present in a nip section of the secondary-transfer rollers 21, and a delivery roller paper detecting sensor SE2 for detecting whether paper P is present in a nip section of the delivery rollers 27. The controller 10 determines a location and a conveying state of paper P based on outputs from these photo sensors and controls a motion of each section of the image forming section 70.

The fixing unit 22 includes a fixing rotating member such as a heating roller 22a and a pressure roller 22b. The fixing rotating member is a rotating member for pinching and conveying paper on which an image is already formed, while heating the same. In addition to the abovementioned pair of rollers, a fixing belt or the like may be used for the fixing rotating member.

The heating roller 22a is provided with heating unit such as halogen lamp heater, extending in the axis direction thereof. The heating roller 22a rotates by being driven by non-illustrated rotation drive unit such as a motor. The pressure roller 22 b is compressed to the heating roller 22a by being driven by non-illustrated compressing drive unit such as a solenoid, and forms a fixing nip between the pressure roller 22b itself and the heating roller 22a. At this time, the pressure roller 22b rotates along with rotation of the heating roller 22a. Thus, the heating roller 22a and the pressure roller 22b heat and press paper P while pinching and conveying the same with the fixing nip thereof, and carry out fusing fix of a toner image on the paper P. Drive control of the rotation drive unit and the compressing drive unit are performed by the controller 10.

As the heating unit 221, in addition to a halogen lamp heater, an induction heater or a resistance heating element may also be used.

Here, when paper P passes through the fixing unit 22, an end of the paper P comes in contact with the fixing rotating member (in this embodiment, the heating roller 22a) of the fixing unit 22. Therefore, if paper P passes through the same place each time, an end of paper causes a scratch, which degrades quality of an image. Thus, in the image forming device 1, the oscillation mechanism 23 is provided beneath the fixing unit 22, and by allowing the oscillation mechanism 23 to oscillate the entire fixing unit 22 in a y direction (the axis direction of the fixing rotating member) orthogonal to the conveying direction x of paper P, paper P is prevented from passing through the same place of the heating roller 22a.

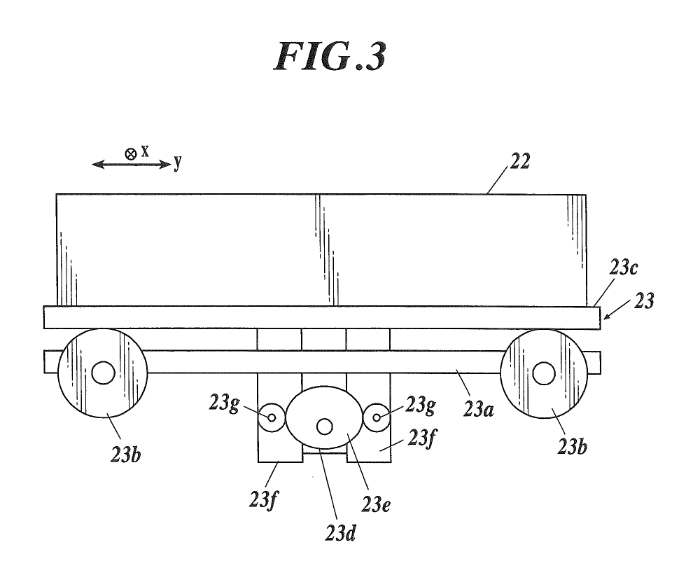

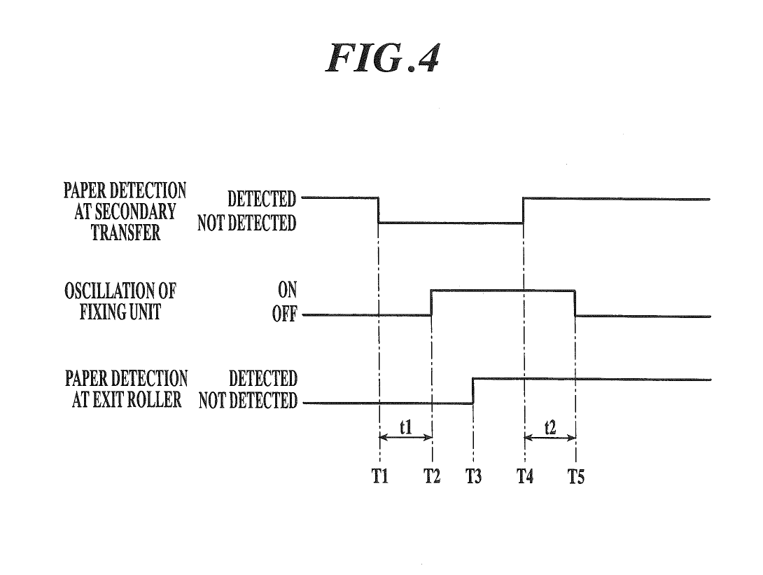

FIG. 3 schematically shows an example of a rough structure of the oscillation mechanism 23. In FIG. 3, the direction x from the front to the back is the conveying direction of paper P, and the direction y orthogonal to this conveying direction is the direction of oscillation. As illustrated in FIG. 4, the oscillation mechanism 23 includes a base 23a fixed inside of the image forming device 1, a pair of support rollers 23b rotatably provided with respect to the base 23a, and an oscillation plate 23c which bridges between the pair of support rollers 23b and on which the fixing unit 22 is mounted.

The base 23a is provided with a first projecting section 23d extending downward. To this first projection section 23d, an eccentric cam 23e is attached in a rotatable manner. Meanwhile, the oscillation plate 23c is provided with a pair of second projecting sections 23f, extending downward. In these second projecting sections 23f, a pair of oscillation rollers 23g is attached in a rotatable fashion, sandwiching the eccentric cam 23e in the direction of oscillation. The pair of oscillation rollers 23g abuts on the eccentric cam 23e, and as the eccentric cam 23e rotates due to driving of a non-illustrated motor, the second projecting sections 23f follow the rotation and oscillate in the direction of oscillation. This means that, since the oscillation reaches the oscillation plate 23c through the second projecting sections 23f, the oscillation plate 23c and the entire fixing unit 22 also oscillate in the direction of oscillation. Drive control of the motor for rotating the eccentric cam 23e is carried out by the controller 10. The oscillation width of the fixing unit 22 is, for example, approximately +/−6 mm. This oscillation width may be changed appropriately depending on fixing conditions and purposes, but should be larger than variation in passing position of paper (up to approximately +/−2 mm).

Here, if the fixing unit 22 is oscillated by the oscillation mechanism 23 in a state where paper P is pinched and conveyed by the pair of rollers of the fixing unit 22 and another pair of rollers at the same time, a problem such as misalignment of an image and wrinkling of paper occurs. Especially when a paper P is being pinched and conveyed simultaneously by the roller pair of the fixing unit 22 and the roller pair of the secondary-transfer rollers 21, the image is directly affected.

In the first embodiment, therefore, the controller 10 controls the drive of the oscillation mechanism 23 according to the timing chart shown in FIG. 4 so that the fixing unit 22 does not swing when each paper P is being pinched and conveyed simultaneously by the roller pair of the fixing unit 22 and the secondary-transfer rollers 21. The secondary-transfer rollers 21 includes a pair of rollers which is adjacent to the fixing unit 22 on the paper transport path and sometimes pinches and conveys a paper P simultaneously with the roller pair of the fixing unit 22.

T1 shown in FIG. 4 indicates timing when the output of the secondary transfer paper detection sensor SE1 changes from a signal indicating detection of paper (“1”, for example) to a signal indicating no detection of paper (“0”, for example). T2 indicates timing when the oscillation mechanism 23 starts being driven thereby the fixing unit 22 starts being oscillated. T3 indicates timing when the output of the delivery roller paper detection sensor SE2 changes from a signal indicating no detection of paper (“0”, for example) to a signal indicating detection of paper (“1”, for example). T4 is timing when the output of the secondary transfer paper detection sensor SE1 changes from the signal indicating no detection of paper (“0”, for example) to the signal indicating detection of paper (“1”, for example). T5 is timing when the next paper P reaches the nip portion of the fixing unit 22 (when the next paper P starts being pinched and conveyed by the fixing unit 22).

In FIG. 4, when the output of the secondary transfer paper detection sensor SE1 changes from the signal indicating detection of paper to the signal indicating no detection of paper, the controller 10 starts clocking a predetermined time period t1 with an internal timer of the CPU. After the predetermined time period t1 has elapsed, the controller 10 determines that the trailing edge of a paper P has gone out of the fixing unit 22 and turns on the oscillation of the fixing unit 22 (T2). To be specific, the controller 10 drives the oscillation mechanism 23 and causes the fixing unit 22 to start oscillating. Herein, t1 refers to a period of time taken for the trailing edge of the paper P to go out of the nip portion of the fixing unit 22 after passing by the secondary transfer paper detection sensor SE1 (from T1). The time period t1 is previously set in the storage section 30.

Subsequently, if the output of the secondary transfer paper detection sensor SE1 changes from the signal indicating no-detection of paper to the signal indicating detection of paper (T4), the controller 10 starts clocking of a predetermined time period t2 by the internal timer of the CPU. After the time period t2 has elapsed, the controller 10 determines that the next paper P reaches the fixing unit 22 and turns off the oscillation of the fixing unit 22 (T5). To be specific, the controller 10 stops driving the oscillation mechanism 23 to stop the oscillation of the fixing unit 22. Herein, the time period t2 refers to a period of time taken for the leading edge of each paper P to reach short of the nip portion of the fixing unit 22 after passing by the secondary transfer paper detection sensor SE1 (from T4). The time period t2 is previously set in the storage section 30.

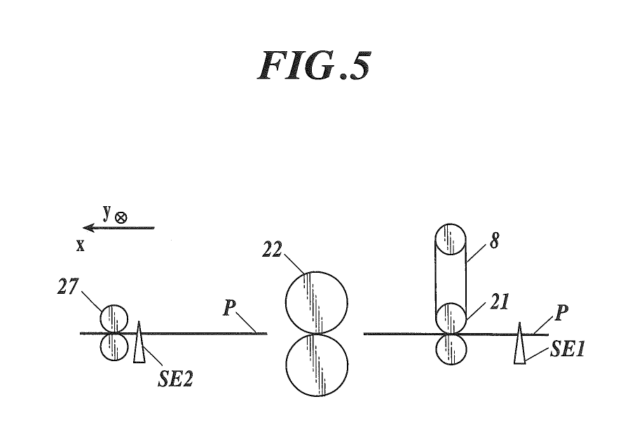

According to the aforementioned control by the controller 10 shown in FIG. 4, the fixing unit 22 can be configured not to oscillate when each paper P is being pinched and conveyed simultaneously by the roller pair of the fixing unit 22 and another roller pair. This can prevent defects including image misalignment and paper wrinkles. In the control shown in FIG. 4, the fixing unit 22 is controlled so as to oscillate after the trailing edge of each paper P passes through the roller pair of the fixing unit 22 until the leading edge of the next paper P reaches the fixing unit 22. In other words, as shown in FIG. 5, the fixing unit 22 is oscillated only when there is no paper P passing through the fixing unit 22. This can further ensure prevention of the influences of the oscillation of the fixing unit 22 on the finished image.

In FIG. 4, the image forming device 1 is configured so that each paper P is not pinched and conveyed simultaneously by the fixing unit 22 and the delivery roller 27 (the paper P is detected at the delivery roller 27 after T2 when the paper P passes through the fixing unit 22). However, the paper P may be pinched and conveyed simultaneously by the fixing unit 22 and the delivery roller 27. Even if the image forming device 1 is configured so that each paper P is pinched and conveyed simultaneously by the fixing unit 22 and the delivery roller 27, the control to oscillate the fixing unit 22 between T2 and T5 as described above allows the fixing unit 22 to oscillate when each paper P is not being pinched and conveyed by the roller pair of the fixing unit 22 simultaneously with the secondary-transfer rollers 21 and/or delivery roller 27. It is therefore possible to prevent image misalignment and paper wrinkles due to oscillation of the fixing unit 22.

### Second Embodiment

Next, a description is given of a second embodiment of the present invention.

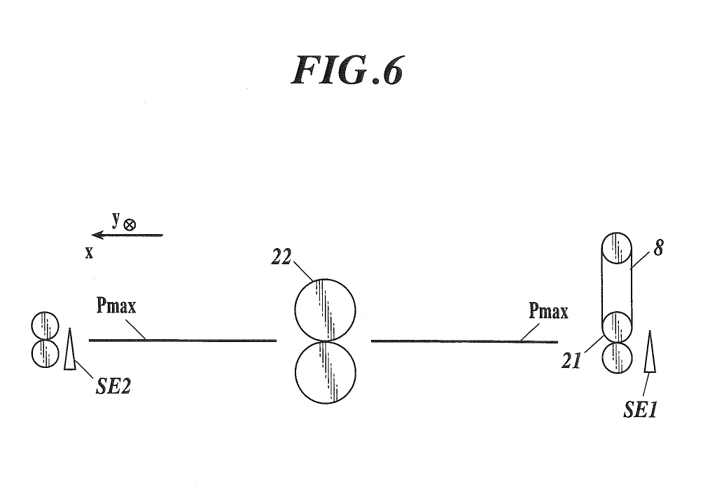

In the second embodiment, as shown in FIG. 6, the distance between the nip portion of the fixing unit 22 and the nip portion of another roller pair is set longer than a maximum paper feeding length of each paper Pmax which is feedable to the image forming device 1 (the length of each paper P in the conveyance direction). The other configuration is the same as that described in the first embodiment.

In the image forming device 1 of the second embodiment, as described above, the distance between the nip portion of the fixing unit 22 and the nip portion of another roller pair is set longer than a maximum paper feeding length of each paper Pmax which is feedable to the image forming device 1. Accordingly, each paper P is not pinched and conveyed simultaneously by the roller pair of the fixing unit 22 and another roller pair irrespective of when the fixing unit 22 starts or stops oscillating. The controller 10 can therefore drive the oscillation mechanism 23 and allow the fixing unit 22 to oscillate only during necessary time period according to the size of paper P and the like irrespective of the outputs of the secondary transfer paper detection sensor SE1 and delivery roller paper detection sensor SE2.

As described above, according to the image forming device 1 of the first embodiment, the controller 10 controls the oscillation mechanism 23 so that the fixing unit 22 does not oscillate when any paper is being pinched and conveyed simultaneously by the fixing rotating members and other rotating members, thus preventing defects including image misalignment and paper wrinkles. Prohibiting the oscillation of the fixing unit 22 while each paper P is being pinched and conveyed simultaneously by the secondary-transfer rollers 21 and roller pair of the fixing unit 22 in particular can ensure prevention of image misalignment.

Moreover, in order to implement the aforementioned control, the controller 10 controls the oscillation mechanism 23 so that the fixing unit 22 oscillates only when each paper P is not being pinched and conveyed by the roller pair of the fixing unit 22. This can further ensure prevention of the influence of oscillation of the fixing unit 22 on finished images.

Furthermore, according to the image forming device 1 of the second embodiment, the distance between the nip portion of the fixing unit 22 and the nip portion of another roller pair is set longer than the maximum paper feeding length of paper Pmax which are feedable to the image forming device 1 (the length of each paper P in the conveyance direction). Accordingly, each paper P is not pinched and conveyed simultaneously by the roller pair of the fixing unit 22 and another roller pair, thus preventing defects including image misalignment and paper wrinkles.

The description of the aforementioned embodiments just show preferred examples of the image forming device according to the present invention and does not limit the present invention.

For example, in the above first embodiment, the image forming device 1 is configured so that each paper P is not pinched and conveyed simultaneously by the roller pair of the fixing unit 22 and another roller pair by control causing the fixing unit 22 to oscillate only when the paper P is not being pinched and conveyed by the roller pair of the fixing unit 22. However, the method of controlling the oscillation of the fixing unit 22 is not limited to such a method.

Moreover, the aforementioned embodiments describe the examples in which the entire fixing unit 22 oscillates in the axial direction. However, the present invention is not limited to such a configuration. For example, provision of a fixing rotating member oscillation mechanism which oscillates at least the fixing rotating members integrally in the axial direction as described in PTL 1 can prevent defects including image misalignment and paper wrinkles.

Moreover, for example, the aforementioned embodiments describe that the image forming device 1 uses the intermediate transfer belt to form an image on paper by the secondary-transfer rollers. For example, like a black-and-white image forming device, the image forming device 1 may be configured so that a toner image formed on a photoreceptor is directly transferred onto paper by transfer rollers.

Furthermore, in the examples disclosed by the above description, the computer readable media for the programs according to the present invention include a ROM, a non-volatile memory, a hard disk, and the like. However, the present invention is not limited to these examples. As another computer readable medium, a portable recording medium such as a CD-ROM is applicable. Moreover, carrier wave is applicable as a medium providing data of the programs according to the present invention through a communication line.

The other detailed configurations and operations of the image forming device 1 can be properly changed without departing from the spirit of the present invention.

The entire disclosure of Japanese Patent Application No. 2011-110257 filed on May 17, 2011 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. An image forming device, comprising:
an image forming section to form an image on a sheet;
a fixing unit to thermally fix the image on the sheet by using a fixing rotating member to pinch and convey the sheet on which the image has been formed by the image forming section;
an oscillation mechanism to oscillate at least the fixing rotating members of the fixing unit in an axial direction thereof; and
a controller to control the oscillation mechanism to cause the fixing rotating members not to oscillate while the sheet is being pinched and conveyed simultaneously by the fixing rotating members and other rotating members.

2. The image forming device according to claim 1, wherein the other rotating members include transfer rollers for transferring the image onto the sheet.

3. The image forming device according to claim 1, wherein the controller controls the oscillation mechanism to cause the fixing rotating members to oscillate only when the sheet is not being pinched and conveyed by the fixing rotating members.

4. A method of controlling an image forming device, comprising the steps of:
forming an image on a sheet by an image forming unit;
thermally fixing the image on the sheet by using fixing rotating members of a fixing unit to pinch and convey the sheet on which the image has been formed;
oscillating at least the fixing rotating members in an axial direction thereof by an oscillation mechanism; and
controlling the oscillation mechanism to cause the fixing rotating members not to oscillate while the sheet is being pinched and conveyed simultaneously by the fixing rotating members and other rotating members.

5. The method according to claim 4, wherein the controller controls the oscillation mechanism to cause the fixing rotating member to oscillate only when the sheet is not being pinched and conveyed by the fixing rotating members.
